(19) United States
(12) Patent Application Publication
(10) Pub. No.: US 2012/0069854 A1
(43) Pub. Date: Mar. 22, 2012

(54) COHERENT OPTICAL RECEIVER AND CONTROL METHOD THEREOF

(76) Inventor: KOUICHI SUZUKI, Tokyo (JP)

(21) Appl. No.: 13/223,810

(22) Filed: Sep. 1, 2011

(30) Foreign Application Priority Data
Sep. 21, 2010 (JP) 210729/2010

(51) Int. Cl. H04J 14/06

(52) U.S. Cl. 370/465; 398/65

(57) ABSTRACT

In a coherent optical receiver according to the invention, a polarization beam splitter inputs a polarization multiplexed optical signal obtained by multiplexing two polarization lights orthogonal to each other modulated by different information signal and separately outputs a first and a second received polarization optical signals, a 90 degree hybrid circuit makes the first and the second received polarization optical signal interfere with local light and outputs a plurality of optical signals, a photoelectric converter detects the optical signal and outputs a detected electric signal, an analog-to-digital converter digitizes the detected electric signal and outputs a digital received signal, a polarization de-multiplexing unit inputs the digital received signal and then outputs results of polarization de-multiplexing process to a phase compensation unit, and the phase compensation unit performs a phase compensation processing using, as an initial value, a phase deviation value obtained by using same initial signal as the information signal.

This application is based upon and claims the benefit of priority from Japanese Patent Application No. 2010-210729, filed on Sep. 21, 2010, the disclosure of which is incorporated herein in its entirety by reference.

### TECHNICAL FIELD

The present invention relates to coherent optical receivers and control methods thereof and, in particular, to a coherent optical receiver and a control method thereof that receive a polarization multiplexed optical signal by means of coherent detection and digital signal processing.

### BACKGROUND ART

In the next-generation optical communication system, higher transmission capacity is required in order to meet the increasing telecommunications needs. In the conventional optical communication system, light intensity modulation (On Off Keying) has been widely used as a modulation system. However, when a bit rate exceeds 40 Gbps, the problem arises that the transmission rate is limited because the influence of wavelength dispersion and polarization mode dispersion becomes greater. The restriction of the characteristics due to such dispersion has a relation that the characteristics deteriorate fourfold when signal symbol rate has doubled. Therefore, in order to improve the characteristics, it is effective to suppress a symbol rate by increasing the bandwidth utilization.

As one of the methods for improving the bandwidth utilization, there is a method to communicate by means of carrying the information on the phase of carrier wave, and the method has been widely used in wireless network systems such as cellular phone systems. However, in optical communication systems, it had been used only in some systems such as a system for CATV (Cable Television). This is because the direct control of the light by electronic circuits is difficult since the frequency of light is very high (about 193.1 THz). Therefore, various methods to down-convert the frequency of light have been developed.

As one of such methods, there is a Sub Carrier Multiplexing (SCM) system. This is a method that electric carrier wave is superposed on the light and information is carried thereon. The Sub Carrier Multiplexing (SCM) system has been put to practical use in some system such as CATV optical transmission system because the SCM system enables a diversion of transmitting and receiving circuits for wireless communications or coaxial transmission line. However, since the maximum bandwidth depends on the performance of electronic circuits according to this method, it is currently difficult to realize a transmission rate greater than or equal to 10 Gbps.

As another method for down-converting the frequency of light, there is an optical coherent receiving system. This is a system that down conversion is performed by mixing signal light and local oscillator (LO) light, and in principle it is almost the same system as the coherent receiving system widely used in wireless communications. In the optical coherent receiving system, it is necessary to match the local oscillator (LO) light with the signal light in the frequency and the phase to the controllable range of an electric circuit, and various methods have been proposed to which the methods used in wireless communication systems are applied.

An example of a coherent optical communication apparatus designed to compensate such fluctuation of the frequency and the phase is described in Japanese Patent Application Laid-Open No. 2008-271527. In this related optical communication apparatus, at the transmitting side, a reference signal, which is a sinusoidal signal, is added to information signal and an optical signal is modulated with the added signal. An optical communication apparatus at the receiving side includes an optical signal generator, an optical hybrid, an optical electrical converter, a compensator, and a demodulator. The optical hybrid couples the modulated optical signal received from the optical communication apparatus at the transmitting side with the local oscillator light generated by the optical signal generator. The optical electrical converter detects the optical signal output from the optical hybrid by heterodyne detection and outputs a detected electrical signal. The compensator detects the fluctuation of the reference signal extracted from the detected electrical signal and compensates frequency fluctuation of the detected electrical signal based on the signal indicating the amount of fluctuation at this time. By such configuration, the fluctuation of the local oscillator light to the received modulated optical signal can be compensated.

Further, in Japanese Patent Application Laid-Open No. 1989-114832, one of the polarization diversity optical receiving systems is disclosed in which signal light combined with local oscillator light is split into orthogonal polarization components and detected. The related optical communication apparatus used for the polarization diversity optical receiving system has intermediate frequency stabilizing means for weighing the output voltage to develop a square value of each detected electrical signals, and adding means for combining voltage outputs of the intermediate frequency stabilizing means. A local oscillator laser is controlled by a control signal which is the sum of the squared values of the electrical signals obtained by the adding means. Thereby the frequency of the local oscillator laser can be stabilized independently of the state of polarization of signal light.

### SUMMARY

An exemplary object of the invention is to provide a coherent optical receiver and a control method thereof, each of which is able to start up stably even though it is used for an optical coherent receiving system using polarization multiplexed optical signal.

A coherent optical receiver according to an exemplary aspect of the invention includes a polarization beam splitter, a 90 degree hybrid circuit, a local oscillator, a photoelectric converter, an analog-to-digital converter, and a digital signal processor, wherein the polarization beam splitter inputs a polarization multiplexed optical signal obtained by multiplexing two polarization lights orthogonal to each other modulated by different information signal respectively, and separately outputs a first received polarization optical signal and a second received polarization optical signal, wherein the 90 degree hybrid circuit makes the first received polarization optical signal and the second received polarization optical signal interfere with local light from the local oscillator respectively and outputs a plurality of optical signals separated into a plurality of signal components, wherein the photoelectric converter detects the optical signal and outputs a detected electric signal, wherein the analog-to-digital converter digitizes the detected electric signal and outputs a digital received signal, wherein the digital signal processor includes a polarization de-multiplexing unit and a phase compensation unit, wherein the polarization de-multiplexing unit inputs the digital received signal and then outputs results of polarization de-multiplexing process to the phase compensation unit, and wherein the phase compensation unit performs a phase compensation processing using, as an initial value, a phase deviation value which is obtained by using same initial signal as the information signal.

A control method of a coherent optical receiver according to an exemplary aspect of the invention includes the steps of inputting a first polarization multiplexed optical signal obtained by multiplexing two polarization lights orthogonal to each other modulated by same initial signal respectively, separating the first polarization multiplexed optical signal into a first received polarization optical signal and a second received polarization optical signal, calculating a phase deviation value using a result from summing each squared value of a first digital received signal and a second digital received signal respectively obtained by coherent detection, performing a phase compensation processing using the phase deviation value as an initial value, and starting up a polarization de-multiplexing processing.

### BRIEF DESCRIPTION OF THE DRAWINGS

Exemplary features and advantages of the present invention will become apparent from the following detailed description when taken with the accompanying drawings in which:

FIG. 1 is a block diagram showing the configuration of a coherent optical receiver in accordance with an exemplary embodiment of the present invention;

FIG. 2 is a flowchart showing a control method for the coherent optical receiver in accordance with the exemplary embodiment of the present invention;

FIG. 3A through FIG. 3F are constellation waveform charts corresponding to each step of the control method for the coherent optical receiver in accordance with the exemplary embodiment of the present invention; and

FIG. 4A and FIG. 4B are block diagrams showing the configurations of a digital signal processing unit in the coherent optical receiver in accordance with the exemplary embodiment of the present invention.

### EXEMPLARY EMBODIMENT

The exemplary embodiment of the present invention will be described below with reference to the drawings.

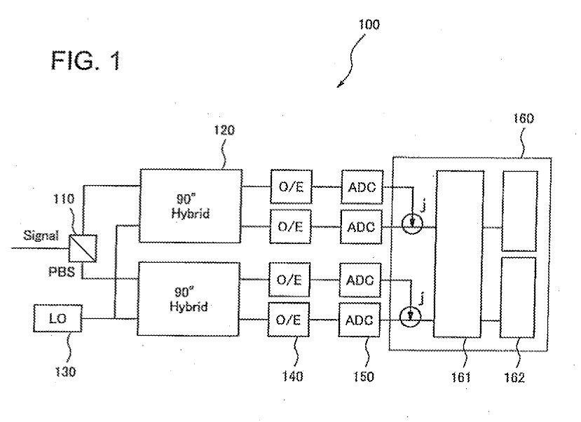

FIG. 1 is a block diagram showing the configuration of a coherent optical receiver 100 in accordance with an exemplary embodiment of the present invention. The coherent optical receiver 100 includes a polarization beam splitter (PBS) 110, a 90 degree hybrid circuit (90° Hybrid) 120, a local oscillator (LO) 130, a photoelectric converter (0/E) 140, an analog-to-digital converter (ADC) 150, and a digital signal processor (DSP) 160.

The polarization beam splitter 110 inputs polarization multiplexed optical signal (Signal) and separately outputs a first received polarization optical signal and a second received polarization optical signal. The polarization multiplexed optical signal is obtained at the transmitting side by multiplexing a first transmitted polarization light (X polarization light) and a second transmitted polarization light (Y polarization light) which are orthogonal to each other and are modulated by different information signal respectively.

The 90 degree hybrid circuit 120 makes the first received polarization optical signal and the second received polarization optical signal interfere with the local light from the local oscillator (LO) 130 respectively and outputs a plurality of optical signals separated into a plurality of signal components. In the present exemplary embodiment, the case will be described in which dual polarization quadrature phase shift keying (DP-QPSK) system is used. Therefore, the 90 degree hybrid circuit (90° Hybrid) 120 outputs four-wave optical signals corresponding to four-channel signal components composed of an in-phase component and a quadrature-phase component for each of two polarizations.

The photoelectric converter (O/E) 140 detects optical signal by coherent detection and outputs detected electric signal. The analog-to-digital converter (ADC) 150 digitizes the detected electric signal and outputs a first digital received signal corresponding to the first received polarization optical signal and a second digital received signal corresponding to the second received polarization optical signal respectively.

The digital signal processor (DSP) 160 is provided with a polarization de-multiplexing unit 161 and a phase compensation unit 162. The polarization de-multiplexing unit 161 inputs the digital received signal and then outputs the results of polarization de-multiplexing process to the phase compensation unit 162. The phase compensation unit 162 performs the phase compensation processing using, as an initial value, a phase deviation (difference) value which is obtained by using the same initial signal as information signal. When the same initial signal is used as information signal, the polarization de-multiplexing unit 161 outputs the results of the calculation that each of the obtained first digital received signal and the second digital received signal is squared respectively and those squared values are added. In the digital signal processor (DSP) 160 according to the present exemplary embodiment, each digital received signal is treated as the complex signal composed of an in-phase component and a quadrature-phase component of each received polarization optical signal.

Although it is explained above that the digital signal processor (DSP) 160 is provided with the polarization de-multiplexing unit 161 and the phase compensation unit 162, there can be other configurations, for example, it can be further provided with a chromatic dispersion compensator that performs the processing for compensating chromatic dispersion.

By adopting such configuration, in the coherent optical receiver 100 according to the present exemplary embodiment, it becomes possible to start up the process by the polarization de-multiplexing unit 161 and the process by the phase compensation unit 162 independently at the time of startup.

That is to say, immediately after the time of startup, the coherent optical receiver 100 receives the first polarization multiplexed optical signal using the same data signal as information signal by which two transmitted polarization lights are modulated. At this time, the polarization de-multiplexing unit 161 in the digital signal processor (DSP) 160 outputs each sum of the squared values of the digital received signal obtained from two received polarization optical signals to the phase compensation unit 162 respectively. The phase compensation unit 162 calculates the phase deviation (difference) value using the input signal from the polarization de-multiplexing unit 161 and performs phase compensation processing using the phase deviation (difference) value at that time as the initial value. And then the polarization de-multiplexing unit 161 starts up the polarization de-multiplexing processing, and performs the processing. This enables the polarization de-multiplexing processing in the polarization de-multiplexing unit 161 and the phase compensation processing in the phase compensation unit 162 to start up independently. As a result, according to the present exemplary embodiment, even though the coherent optical receiver 100 is used for the optical coherent receiving system using the polarization multiplexed optical signal, its stable start-up becomes possible.

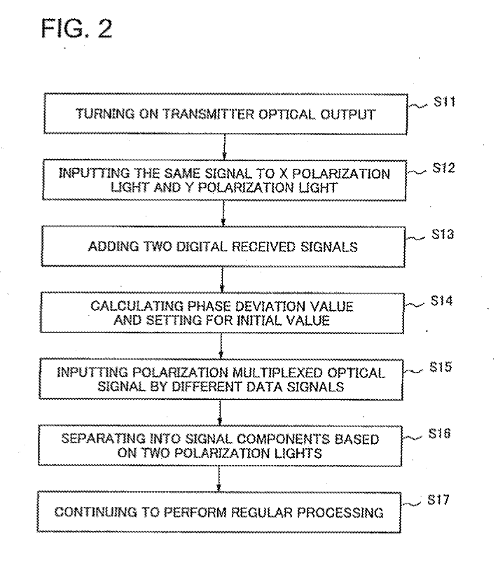

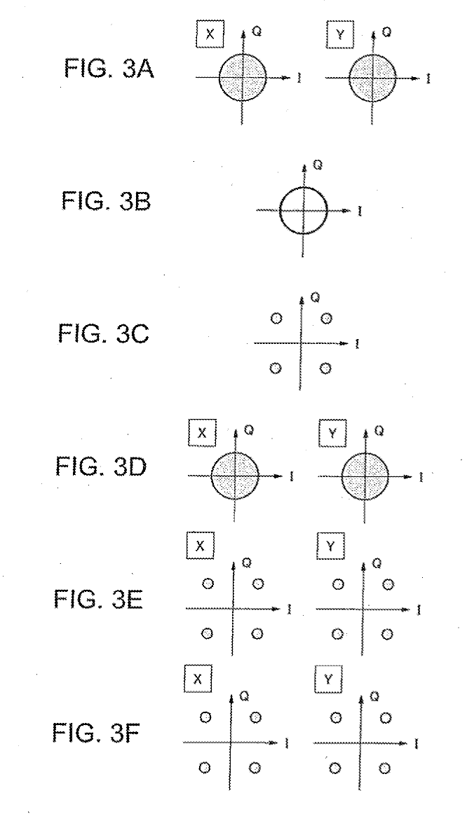

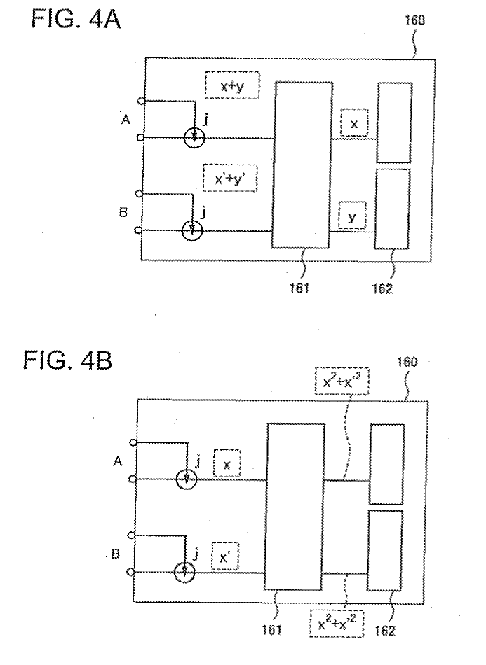

Next, the operation of the coherent optical receiver 100 according to the present exemplary embodiment will be described in further detail using FIGS. 2, 3A to 3F, 4A, and 4B in addition to FIG. 1. FIG. 2 is a flowchart showing a control method for the coherent optical receiver in accordance with the present exemplary embodiment. FIG. 3A through FIG. 3F are constellation waveform charts corresponding to each step of the control method for the coherent optical receiver in accordance with the present exemplary embodiment. FIG. 4A and FIG. 4B are block diagrams showing the configurations of a digital signal processing unit in the coherent optical receiver in accordance with the present exemplary embodiment.

The coherent optical receiver 100 receives a polarization multiplexed optical signal from the transmitting side. At the transmitting side, optical output from a transmitter is turned on (ON-state) (step S11 in FIG. 2), and two polarization lights (X polarization light and Y polarization light) in optical output are modulated respectively by information (data) signal. And then, these modulated optical signals are multiplexed and transmitted as a polarization multiplexed optical signal.

As shown in FIG. 1, in the coherent optical receiver 100, the inputted polarization multiplexed optical signal is separated into two polarization lights by the polarization beam splitter (PBS) 110, which are inputted into two 90 degree hybrid circuits (90° Hybrid) 120 respectively.

At the time of an initial operation, the same initial signal is applied to the two polarization lights at the transmitting side. For example, if data signal of [010011] is inputted into the first transmitted polarization light (X polarization light), the same data signal of [010011] is also inputted into the second transmitted polarization light (Y polarization light) (step S12 in FIG. 2, and FIG. 3A).

The polarization multiplexed transmitted light composed of each transmitted polarization light, to which the same data signal is applied, reaches the coherent optical receiver 100 with polarization angle varying randomly during propagating through an optic fiber. Therefore, its polarization does not necessarily match the polarization of the local oscillator (LO) light from the local oscillator (LO) 130. When the polarization angle of the signal light does not match that of the local oscillator (LO) light, the optical power received by each of the 90 degree hybrid circuits (90° Hybrid) 120 fluctuates by the amount of cos² θ, where the symbol of θ represents the difference between the polarization angle of the signal light and that of the local oscillator (LO) light. For this reason, a fluctuation in the receiving characteristic arises, which leads to difficulty in performing phase control processing in later stages if a difference in polarization angle cannot be locked by means of the processing using CMA (Constant Modulus Algorithm) or the like.

When operating in the steady state, as shown in FIG. 4A, the received optical signal needs transmitting to the phase compensation unit 162 in the later stage after separating the signal component x of the first transmitted polarization light (X polarization light) and the signal component y of the second transmitted polarization light (Y polarization light) from the received optical signal.

If the signal component x of X polarization light and the signal component y of Y polarization light are mixed, since they have different phase respectively, two types of light with two phases cannot be matched by just one type of local oscillator (LO) light. If two types of local oscillator are provided, since it is difficult to match the phase between two types of local oscillator (LO) light, it becomes difficult to receive properly.

On the other hand, in order to match the polarization of the received light with that of the local oscillator (LO) light, there is a known method of extracting the polarization angle of the received light and forcibly matching it with that of the local oscillator (LO) light by a polarization stabilizer. However, the implementation of the method is difficult because the system becomes complicated.

In contrast, according to the coherent optical receiver and the control method thereof of the present exemplary embodiment, these problems are able to be solved as mentioned above. It will be described in further detail below.

As shown in FIG. 4B, the first digital received signal and the second digital received signal are inputted into two input ports A and B in the digital signal processor (DSP) 160 respectively. At this time, the first polarization multiplexed optical signal, which are obtained by multiplexing two transmission polarization lights respectively modulated by the same data signal αₘ at the transmitting side, is inputted into the coherent optical receiver 100. Here, if the symbol of φ represents the phase deviation (difference) value between the signal light and the local oscillator (LO) light and the symbol of θ represents the difference in the polarization angle, a first digital received signal component x at the input port A and a second digital received signal component x′ at the input port B are expressed in the following formulas.

x=αₘ(cos φ+j sin)cos θ (1)

x′=αₘ(cos φ+j sin φ)sin θ (2)

In the polarization de-multiplexing unit 161, the first digital received signal is added to the second digital received signal on the I-Q plane (step S13 in FIG. 2, and FIG. 3B). That is to say, the polarization de-multiplexing unit 161 outputs the results from summing the squared values of the digital received signal components respectively expressed by the formulas of (1) and (2). Where using the trigonometric identity, that is, cos² θ+sin² θ=1, the fluctuation in the optical output due to the fluctuation of the polarization angle is able to be canceled as described below.

$$\begin{matrix}{x}^{2} + {x}^{′2} = {{α}_{m}^{2} ( cos φ + j sin φ )}^{2} ( {cos}^{2} θ + {sin}^{2} θ ) \\ = {{α}_{m}^{2} ( cos φ + j sin φ )}^{2} \\ = {α}_{m}^{2} ( 1 - 2 {sin}^{2} φ + 2 j cos φ sin φ ) \\ = {α}_{m}^{2} ( cos 2 φ + j sin 2 φ )\end{matrix} \qquad ( 3 )$$

As shown in the formula (3), the fluctuation due to the polarization angle is canceled and the polarization dependency in the received polarization optical signal is removed (FIG. 3B). On the other hand, the phase information is converted into a double angular frequency. As a result, it becomes possible to detect the phase deviation (difference) value only without depending on the difference in the polarization angle between the signal light and the local oscillator (LO) light. That is to say, before performing the polarization de-multiplexing processing, it becomes possible to execute beforehand the phase compensation processing which compensates the phase deviation (difference) arising from the difference in the wavelength between the local oscillator (LO) light and the signal light, and so on.

At that time, as shown in FIG. 4B, the polarization de-multiplexing unit 161 outputs the sum of the squared values “x²+x′²” of the digital received signal of x and x′ inputted from the input ports of A and B. Afterwards, the phase compensation unit 162 calculates the phase deviation (difference) value of “2 φ”, and sets this “φ” for an initial value of the compensation process (step S14 in FIG. 2, and FIG. 3C). The phase compensation unit 162 corrects this phase difference “φ” beforehand.

Next, the second polarization multiplexed optical signal, which are obtained by multiplexing two transmitted polarization lights respectively modulated by different data signals at the transmitting side, is transmitted. And then, the coherent optical receiver 100 receives the second polarization multiplexed optical signal (step S15 in FIG. 2, and FIG. 3D).

The polarization beam splitter 110 separates the second polarization multiplexed optical signal into a third received polarization optical signal and a fourth received polarization optical signal and outputs them. In the 90 degree hybrid circuit (90° Hybrid) 120 and the photoelectric converter (O/E) 140, the third received polarization optical signal and the fourth received polarization optical signal are made to interfere with the local light respectively and detected. The analog-to-digital converter (ADC) 150 outputs the third digital received signal and the fourth digital received signal which are obtained by digitizing the detected signals respectively.

At this time, the polarization de-multiplexing unit 161 in the digital signal processor (DSP) 160 starts performing the polarization de-multiplexing processing on the third digital received signal and the fourth digital received signal, and separates them into signal components (x and y) based on two polarization lights (X polarization light and Y polarization light) (step S16 in FIG. 2, and FIG. 3E). Thereafter, the polarization de-multiplexing unit 161 and the phase compensation unit 162 continue to perform the regular processing of polarization de-multiplexing and phase compensation (step S17 in FIG. 2, and FIG. 3F).

As mentioned above, according to the coherent optical receiver and the control method thereof in accordance with the present exemplary embodiment, it becomes possible to start up the polarization de-multiplexing unit and the phase compensation unit independently. Therefore, even though the coherent optical receiver is used for the optical coherent receiving system using the polarization multiplexed optical signal, its stable start-up becomes possible.

As described in the background art, in the optical coherent receiving system, it is necessary to compensate the phase deviation (difference) arising from the difference in the wavelength between the local oscillator (LO) light and the signal light, and so on.

On the other hand, in order to realize higher transmission capacity in the optical communication system, an optical polarization multiplexing system, which transmits a polarization multiplexed optical signal carrying the information independently on two polarization lights orthogonal to each other, has been used. Here, in the optical polarization multiplexing communication system, if the polarization axis of the signal light does not coincide with that of the local oscillator (LO) light, a signal cannot be transmitted properly because the two lights cannot be multiplexed. For this reason, the means of locking a polarization of a signal light by using a polarization stabilizer or the like has been taken, but its control means becomes complicated. On the other hand, a processing method of separating a signal carried on two multiplexed polarization lights into two signals by using CMA (Constant Modulus Algorithm) method has been proposed, and an optical polarization multiplexed communication system using this technology has been studied.

In this way, in the optical coherent receiving system using the polarization multiplexed optical signal, a coherent optical receiver needs to perform both phase compensation processing and polarization de-multiplexing processing. When performing the phase compensation processing mentioned above, if neither phase compensation processing nor polarization de-multiplexing processing is properly performed at the time of startup of a related coherent optical receiver, a received signal cannot be extracted and a related coherent optical receiver cannot be stably started up.

In this way, in the optical coherent receiving system using the polarization multiplexed optical signal, there is a problem that the operation at the time of startup of the related coherent optical receiver is unstable.

An exemplary advantage according to the invention is that the coherent optical receiver is able to start up stably even though it is used for an optical coherent receiving system using polarization multiplexed optical signal.

While the invention has been particularly shown and described with reference to exemplary embodiment thereof, the invention is not limited to the embodiment. It will be understood by those of ordinary skill in the art that various changes in form and details may be made therein without departing from the spirit and scope of the present invention as defined by the claims.

1. A coherent optical receiver, comprising:
a polarization beam splitter;
a 90 degree hybrid circuit;
a local oscillator;
a photoelectric converter;
an analog-to-digital converter; and
a digital signal processor;
wherein the polarization beam splitter inputs a polarization multiplexed optical signal obtained by multiplexing two polarization lights orthogonal to each other modulated by different information signal respectively, and separately outputs a first received polarization optical signal and a second received polarization optical signal;
wherein the 90 degree hybrid circuit makes the first received polarization optical signal and the second received polarization optical signal interfere with local light from the local oscillator respectively and outputs a plurality of optical signals separated into a plurality of signal components;
wherein the photoelectric converter detects the optical signal and outputs a detected electric signal;
wherein the analog-to-digital converter digitizes the detected electric signal and outputs a digital received signal;
wherein the digital signal processor includes a polarization de-multiplexing unit and a phase compensation unit;
wherein the polarization de-multiplexing unit inputs the digital received signal and then outputs results of polarization de-multiplexing process to the phase compensation unit; and
wherein the phase compensation unit performs a phase compensation processing using, as an initial value, a phase deviation value which is obtained by using same initial signal as the information signal.

2. The coherent optical receiver according to claim 1,
wherein the polarization de-multiplexing unit outputs each sum of squared values of the digital received signal which is obtained by using the same initial signal as the information signal.

3. A control method of a coherent optical receiver, comprising the steps of:
inputting a first polarization multiplexed optical signal obtained by multiplexing two polarization lights orthogonal to each other modulated by same initial signal respectively;
separating the first polarization multiplexed optical signal into a first received polarization optical signal and a second received polarization optical signal;
calculating a phase deviation value using a result from summing each squared value of a first digital received signal and a second digital received signal respectively obtained by coherent detection;
performing a phase compensation processing using the phase deviation value as an initial value; and
starting up a polarization de-multiplexing processing.

4. A control method of a coherent optical receiver, comprising the steps of:
inputting a first polarization multiplexed optical signal obtained by multiplexing two polarization lights orthogonal to each other modulated by same initial signal respectively;
separating the first polarization multiplexed optical signal into a first received polarization optical signal and a second received polarization optical signal;
making a first received polarization optical signal and a second received polarization optical signal interfere with a local light respectively and detecting them;
outputting a first digital received signal and a second digital received signal obtained by digitizing detected signals respectively;
calculating a phase deviation value using a result from summing each squared value of the first digital received signal and the second digital received signal; and
performing a phase compensation processing using the phase deviation value as an initial value.

5. The control method of the coherent optical receiver according to claim 4, further comprising:
inputting a second polarization multiplexed optical signal obtained by multiplexing two polarization lights orthogonal to each other modulated by different information signal respectively after performing the phase compensation processing using the phase deviation value as an initial value;
separating the second polarization multiplexed optical signal into a third received polarization optical signal and a fourth received polarization optical signal;
making the third received polarization optical signal and the fourth received polarization optical signal interfere with a local light respectively and detecting them;
outputting a third digital received signal and a fourth digital received signal obtained by digitizing detected signals respectively; and
performing a polarization de-multiplexing processing and a phase compensation processing on the third digital received signal and the fourth digital received signal respectively.
